(19) United States
(12) Patent Application Publication
(10) Pub. No.: US 2015/0091943 A1
(43) Pub. Date: Apr. 2, 2015

(54) WEARABLE DISPLAY DEVICE AND METHOD FOR CONTROLLING LAYER IN THE SAME

(71) Applicant: LG ELECTRONICS INC., SEOUL (KR)

(72) Inventors: Doyoung LEE, Seoul (KR); Sinae CHUN, Seoul (KR); Eunhyung CHO, Seoul (KR); Jihwan KIM, Seoul (KR)

(73) Assignee: LG ELECTRONICS INC., SEOUL (KR)

(21) Appl. No.: 14/167,058

(22) Filed: Jan. 29, 2014

(30) Foreign Application Priority Data
Sep. 30, 2013 (KR) 10-2013-0116713

(51) Int. Cl. G02B 27/01; G06F 3/01; G06T 19/00

(52) U.S. Cl. CPC G02B 27/0172; G06T 19/006; G06F 3/012; G06F 3/013; G02B 2027/0178
USPC 345/633; 345/8

(57) ABSTRACT

Discussed are a wearable display device and a method for controlling an augmented reality layer. The wearable display device may include a camera unit configured to capture an image of a user's face, a sensor unit configured to sense whether or not the user is turning his (or her) head, and a controller configured to move a virtual object belonging to a layer being gazed upon by the user's eye-gaze, when at least one of a turning of the user's head and a movement in the user's eye-gaze is identified based upon the image of the user's face captured by the camera unit and information sensed by the sensor unit, and when the user's eye-gaze is gazing upon any one of a first virtual object belonging to a first layer and a second virtual object belonging to a second layer.

Pursuant to 35 U.S.C. §119(a), this application claims the benefit of the Korean Patent Application No. 10-2013-0116713, filed on Sep. 30, 2013, which is hereby incorporated by reference as if fully set forth herein.

### BACKGROUND OF THE INVENTION

1. Field of the Invention

The present specification relates to a wearable display (or computing) device that can be worn on at least one body part of the user and, more particularly, to an Augmented Reality (AR) layer controlling method in a wearable display device that can be worn on the user's face.

2. Discussion of the Related Art

The augmented reality (AR) technology, which corresponds to a combination of a real object and a virtual object, allows the user to view a virtual image along with a real image, so as to provide the user with a sense of reality and supplemental information at the same time. For example, when the user's surroundings are seen through a camera, which is equipped in a smart phone, the real image of the user's surroundings is displayed along with an augmented reality image, such as a location, a telephone number, and so on, of a shop (or store) located near-by, in the form of a stereoscopic image (or three-dimensional (3D) image). The augmented reality technology may be applied to a wearable display device. Most particularly, a display that is worn on the head, such as a head mounted display, displays an environment that is actually seen (or viewed) by the user, wherein the displayed environment is being overlapped in real-time with a virtual image or text, and so on, thereby providing the user with an augmented reality.

By exceeding the simple display function and being combined with the above-described augmented reality technology, N screen technology, and so on, the wearable display device may provide the user with diverse convenience.

Additionally, the wearable display device may be used in connection with diverse types of external digital devices. The wearable display device may perform communication with an external digital device, so as to receive a user input for the corresponding external digital device or to perform an operation connected to the corresponding external digital device.

(a) to (d) of FIG. 1 respectively illustrate diverse forms of wearable display devices. As shown in (a) to (d) of FIG. 1, the wearable display device may have a wide range of forms, and the device form may correspond to any device type that can be worn on the head or face. For example, diverse forms, such as a eye glasses type (or viewing glasses type) shown in (a) of FIG. 1, a sunglasses type shown in (b) of FIG. 1, and hair band types (or head band or head set types) shown in (c) and (d) of FIG. 1, may be provided.

The wearable display device shown in (a) to (d) of FIG. 1 provides images and/or sound (or voice) through a display and/or speakers. Most particularly, a general method of the wearable display device is to be equipped with a compact display device, such as a liquid crystal display, located near at least one of the two eyes of the user, so that images can be projected through the compact display device.

### SUMMARY OF THE INVENTION

An object of the present specification is to provide a device and method for controlling an augmented reality layer in a wearable display device.

Another object of the present specification is to provide a device and method for controlling an augmented reality layer in a wearable display device by using the user's eye-gaze and rotation of the wearable display device (Le., turning of the user's head).

Additional advantages, objects, and features of the specification will be set forth in part in the description which follows and in part will become apparent to those having ordinary skill in the art upon examination of the following or may be learned from practice of the specification. The objectives and other advantages of the specification may be realized and attained by the structure particularly pointed out in the written description and claims hereof as well as the appended drawings.

To achieve these objects and other advantages and in accordance with the purpose of the specification, as embodied and broadly described herein, a wearable display device may include a display unit configured to display a first virtual object belonging to a first layer and a second virtual object belonging to a second layer, a camera unit configured to capture an image of a user's face, a sensor unit configured to sense whether the user is turning his (or her) head, and a controller configured to move a virtual object belonging to a layer being gazed upon by the user's eye-gaze when at least one of a turning of the user's head and a movement in the user's eye-gaze is identified based on the image of the user's face captured by the camera unit and information sensed by the sensor unit, and when the user's eye-gaze is gazing upon any one of the first virtual object belonging to the first layer and the second virtual object belonging to the second layer.

According to an embodiment of the present specification, the controller detects pupils of the user's eyes from the captured image of the user's face and detects a gazing direction of the user's eye-gaze based on the detected pupil information and whether the user has turned his (or her) head.

According to an embodiment of the present specification, the controller moves the virtual object belonging to the layer being gazed upon by the user's eye-gaze, when the user's eye-gaze is in a fixed state, while the user's eye-gaze is gazing upon any one of the first virtual object belonging to the first layer and the second virtual object belonging to the second layer, and when the user's head is turned sideways.

According to an embodiment of the present specification, a moving direction of the virtual object belonging to the layer that is being moved corresponds to an opposite direction of a turning direction of the user's head.

According to an embodiment of the present specification, a moving distance of the virtual object belonging to the layer that is being moved is calculated based on a turning distance of the user's head.

According to an embodiment of the present specification, the controller moves the virtual object belonging to the layer being gazed upon by the user's eye-gaze, when the user's head is in a fixed state, while the user's eye-gaze gazes upon any one of the first virtual object belonging to the first layer and the second virtual object belonging to the second layer, and when the user's eye-gaze is moved afterwards.

According to an embodiment of the present specification, a moving direction of the virtual object belonging to the layer that is being moved corresponds to the same direction as a moving direction of the user's eye-gaze.

According to an embodiment of the present specification, a moving distance of the virtual object belonging to the layer that is being moved is calculated based on a moving distance of the user's eye-gaze.

According to an embodiment of the present specification, the controller senses a turning direction and a turning distance of the user's head by using at least one of a motion sensor, an acceleration sensor, and a gyro sensor.

According to an embodiment of the present specification, the controller senses a turning direction and a turning distance of the user's head based on the captured image of the user's face.

According to an embodiment of the present specification, the camera unit captures a reality image and the display unit displays an augmented reality image by overlaying the first virtual object belonging to the first layer and the second virtual object belonging to the second layer over the captured reality image.

According to an embodiment of the present specification, a method for controlling a layer in a wearable display device may include displaying a first virtual object belonging to a first layer and a second virtual object belonging to a second layer, capturing an image of a user's face, sensing whether the user is turning his (or her) head, and moving a virtual object belonging to a layer being gazed upon by the user's eye-gaze, when at least one of a turning of the user's head and a movement in the user's eye-gaze is identified based on the captured image of the user's face and the sensed information, and when the user's eye-gaze is gazing upon any one of the first virtual object belonging to the first layer and the second virtual object belonging to the second layer.

It is to be understood that both the foregoing general description and the following detailed description of the present specification are exemplary and explanatory and are intended to provide further explanation of the present specification as claimed.

### BRIEF DESCRIPTION OF THE DRAWINGS

The accompanying drawings, which are included to provide a further understanding of the present specification and are incorporated in and constitute a part of this application, illustrate embodiment(s) of the present specification and together with the description serve to explain the principle of the present specification. In the drawings:

(a) to (d) of FIG. 1 respectively illustrate diverse forms of wearable display devices;

FIG. 2 illustrates a block diagram showing a structure of a wearable display device according to the present specification;

(a) to (d) of FIG. 3 respectively illustrate examples of movement in the user's eye-gaze and turning of the user's head according to the present specification;

(a) and (b) of FIG. 4 respectively illustrate examples of a user viewing an augmented reality image, when the user is wearing the wearable display device according to an exemplary embodiment of the present specification;

(a) and (b) of FIG. 5 respectively illustrate examples of a user viewing an augmented reality image, when the user is wearing the wearable display device according to another exemplary embodiment of the present specification;

(a) and (b) of FIG. 6 respectively illustrate examples of a user viewing an augmented reality image, when the user is wearing the wearable display device according to yet another exemplary embodiment of the present specification; and

FIG. 7 illustrates a flow chart showing process steps of a method for controlling an augmented reality layer according to an exemplary embodiment of the present specification.

### DETAILED DESCRIPTION OF THE INVENTION

Reference will now be made in detail to the preferred embodiments of the present specification, examples of which are illustrated in the accompanying drawings. Wherever possible, the same reference numbers will be used throughout the drawings to refer to the same or like parts.

Hereinafter, preferred exemplary embodiments of the present specification that can best carry out the above-described objects of the preset specification will be described in detail with reference to the accompanying drawings. At this point, the structure or configuration and operations of the present specification, which are illustrated in the drawings and described with respect to the drawings, will be provided in accordance with at least one exemplary embodiment of the present specification. And, it will be apparent that the technical scope and spirit of the present specification and the essential structure and operations of the present specification will not be limited only to the exemplary embodiments set forth herein.

In addition, although the terms used in the present specification are selected from generally known and used terms, the terms used herein may be varied or modified in accordance with the intentions or practice of anyone skilled in the art, or along with the advent of a new technology. Alternatively, in some particular cases, some of the terms mentioned in the description of the present specification may be selected by the applicant at his or her discretion, the detailed meanings of which are described in relevant parts of the description herein. Furthermore, it is required that the present specification is understood, not simply by the actual terms used but by the meaning of each term lying within.

Specific structural and functional description of the present specification respective to the exemplary embodiments, which are provided in accordance with the concept of the present specification disclosed in the present specification, is merely an exemplary description provided for the purpose of describing the exemplary embodiments according to the concept of the present specification. And, therefore, the exemplary embodiment of the present specification may be realized in diverse forms and structures, and, it should be understood that the present specification is not to be interpreted as being limited only to the exemplary embodiments of the present specification, which are described herein.

Since diverse variations and modifications may be applied to the exemplary embodiments according to the concept of the present specification, and, since the exemplary embodiments of the present specification may be configured in diverse forms, specific embodiment of the present specification will hereinafter be described in detail with reference to the examples presented in the accompanying drawings. However, it should be understood that the exemplary embodiments respective to the concept of the present specification will not be limited only to the specific structures disclosed herein. And, therefore, it should be understood that all variations and modifications, equivalents, and replacements, which are included in the technical scope and spirit of the present specification, are included.

Additionally, in the present specification, although terms such as first and/or second may be used to describe diverse elements of the present specification, it should be understood that the elements included in the present specification will not be limited only to the terms used herein. The above-mentioned terms will only be used for the purpose of differentiating one element from another element, for example, without deviating from the scope of the present specification, a first element may be referred to as a second element, and, similarly, a second element may also be referred to as a first element.

Moreover, throughout the entire description of the present specification, when one part is said to “include (or comprise)” an element, unless specifically mentioned otherwise, instead of excluding any other element, this may signify that the one part may further include other elements. Furthermore, the term “unit (or part)”, which is mentioned in the present specification, refers to a unit for processing at least one function or operation, and this may be realized in the form of hardware, software, or in a combination of both hardware and software.

The present specification relates to having the wearable display device control an augmented reality layer by using the user's eye-gaze and the turning of the user's head. Most particularly, the present specification relates to moving the virtual image of a specific layer by using the user's eye-gaze and the turning of the user's head from an augmented reality image, which is created by aligning (or positioning) two or more virtual objects through two or more layers. If the wearable display device is in a state of being worn on the user's head, the rotation of the wearable display device and the turning of the user's head may have the same meaning.

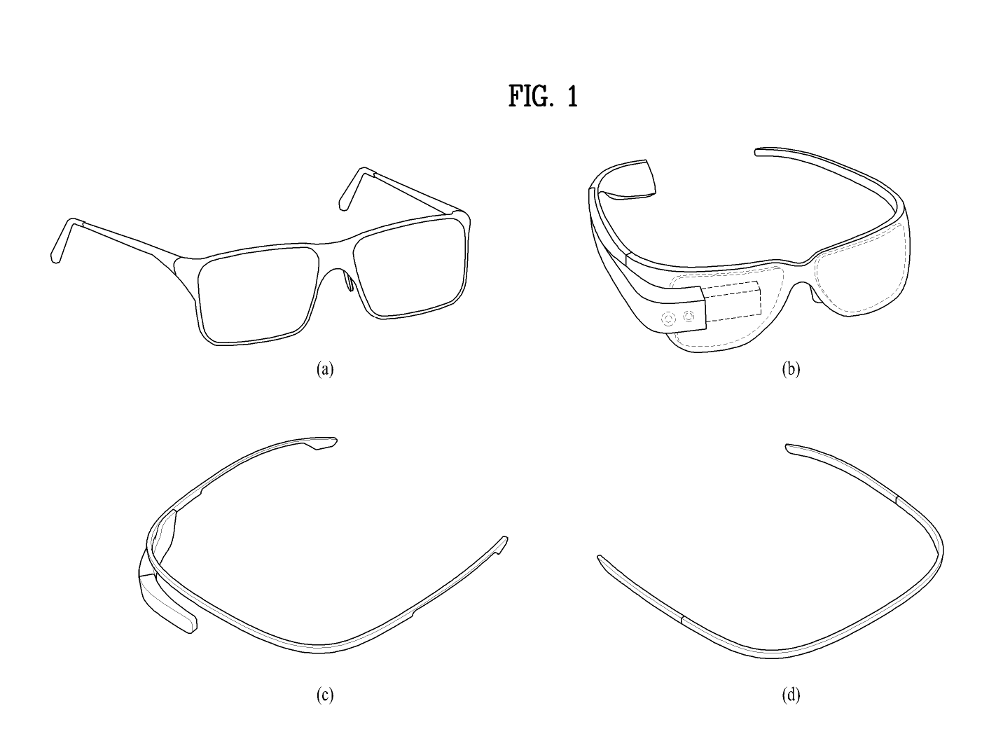

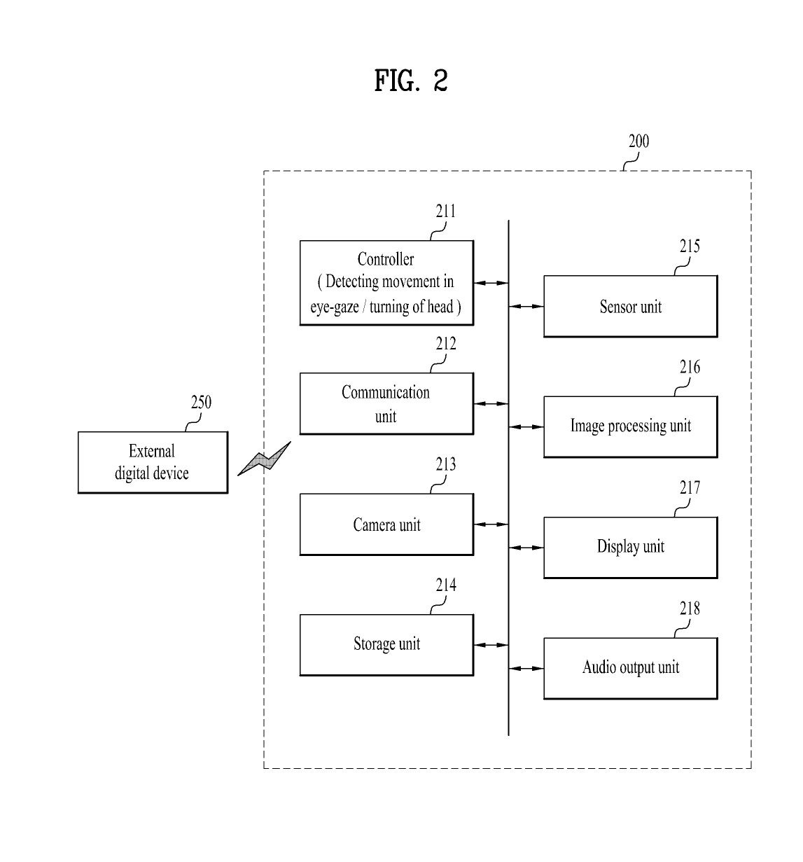

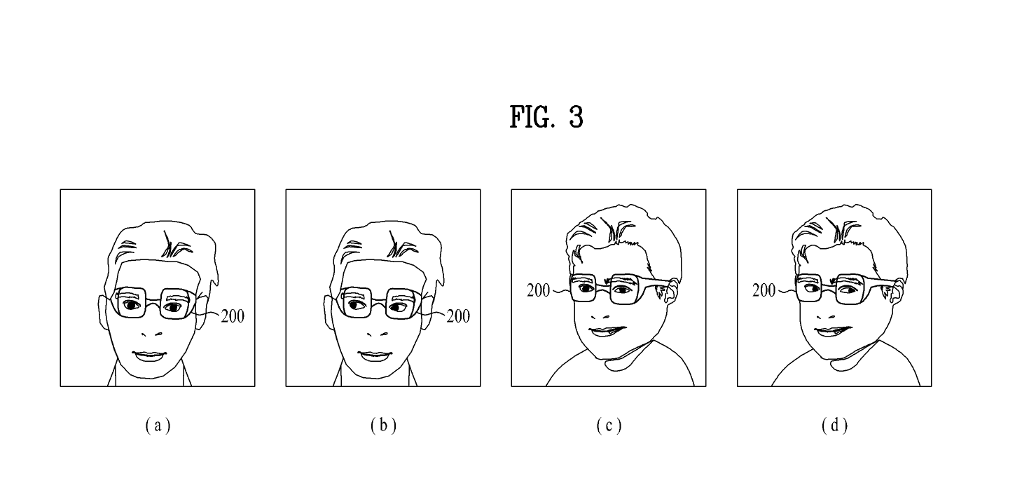

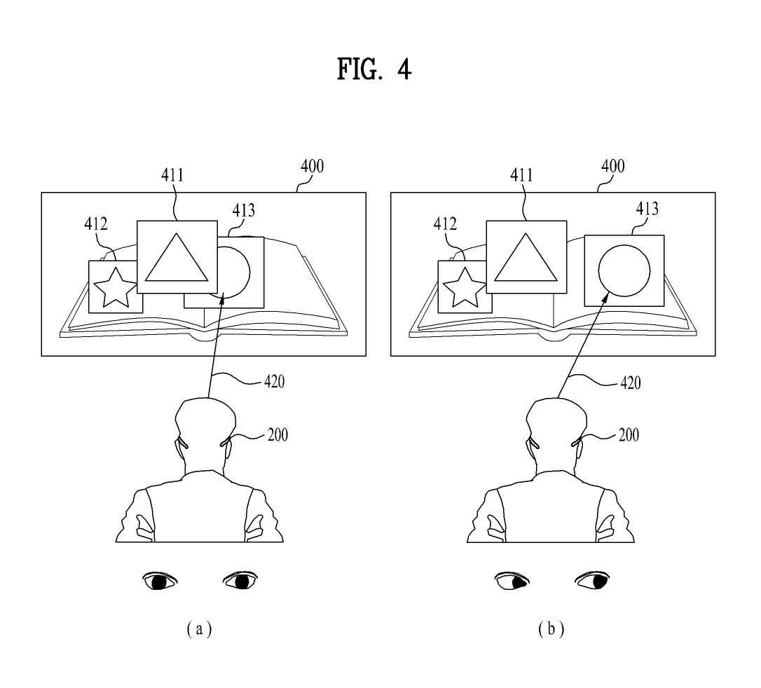

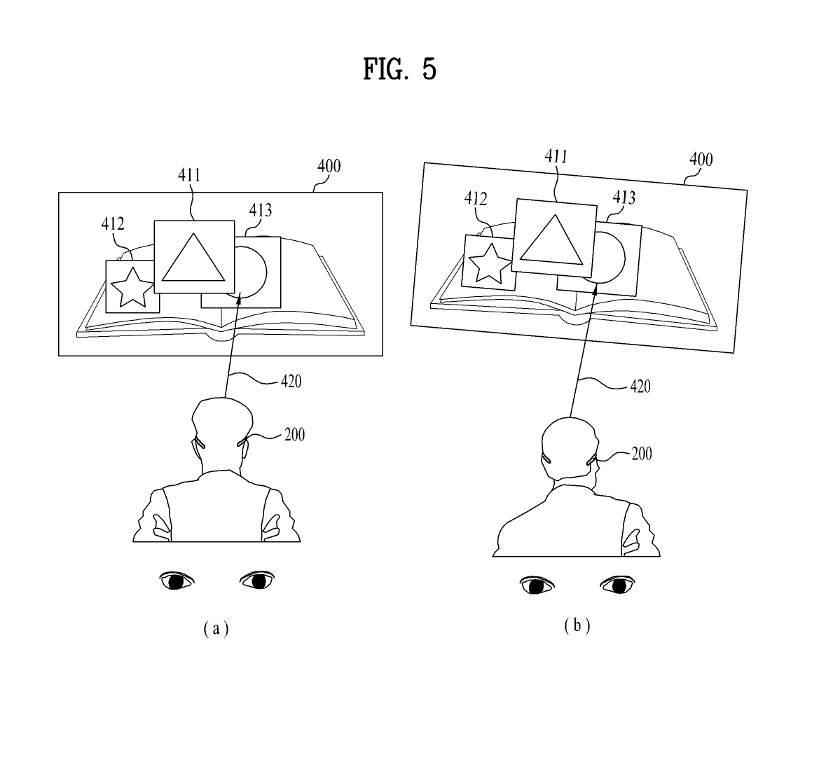

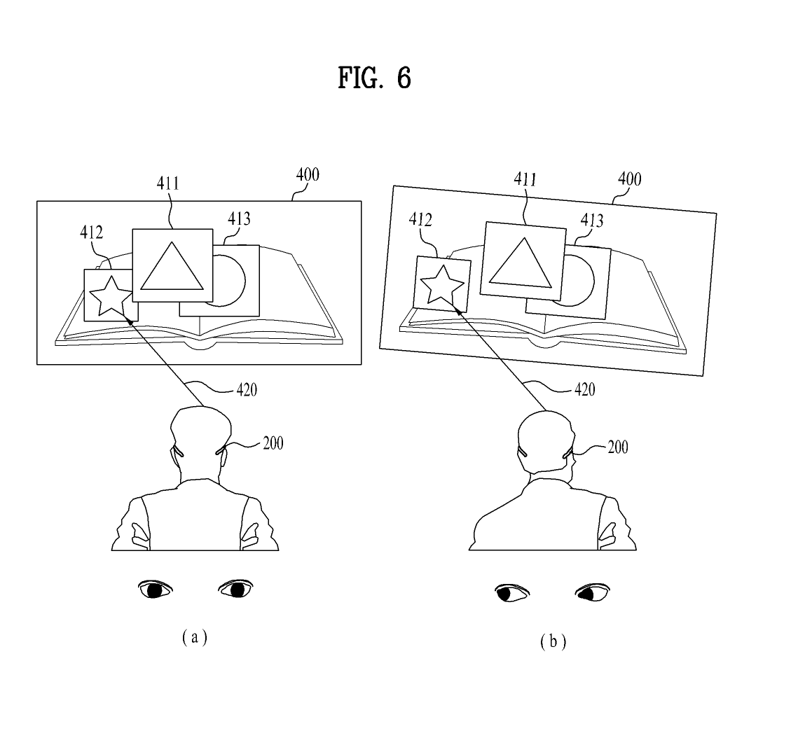

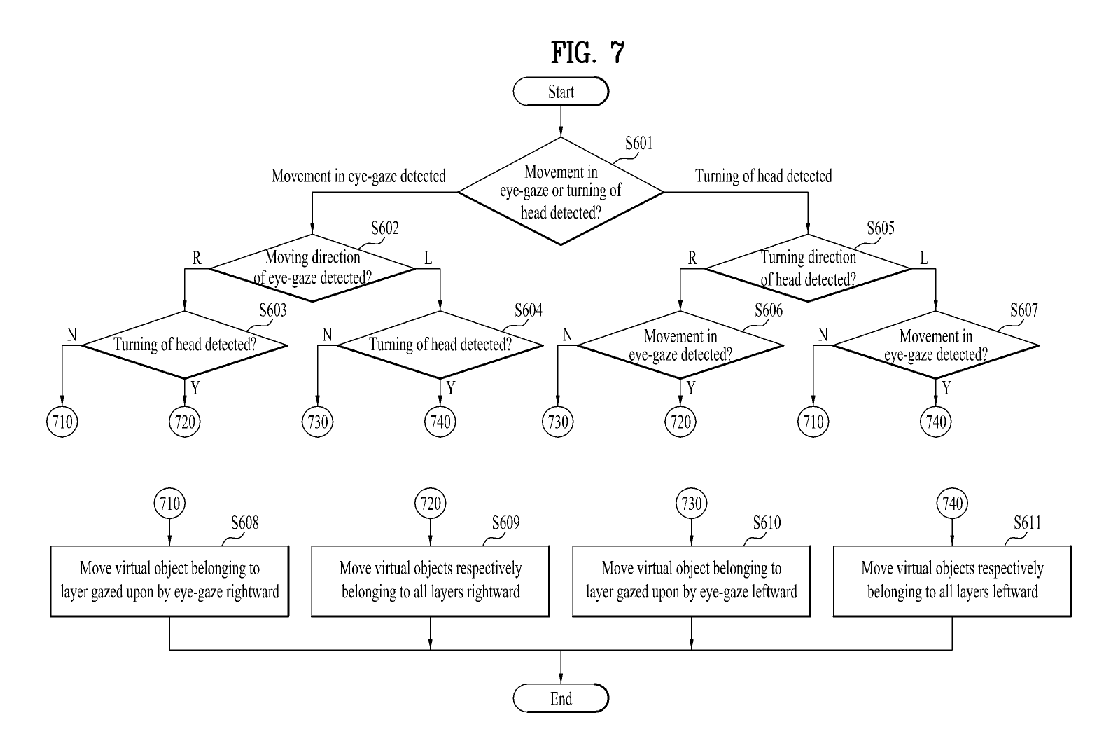

FIG. 2 illustrates a block diagram of showing the structure of a wearable display device 200 according to an exemplary embodiment of the present specification, wherein the wearable display device 200 includes a controller 211, a communication unit 212, a camera unit 213, a storage unit 214, a sensor unit 215, an image processing unit 216, a display unit 217, and an audio outputting unit 218. Additionally, one or more external digital devices 250 providing data, such as content, are connected to the communication unit 212 of the wearable display device 200.

In the wearable display device 200 having the above-described structure, the controller 211 may execute an application (or program) and may process data existing in the wearable display device 200. Moreover, the controller 211 may control the communication unit 212, the camera unit 213, the storage unit 214, the sensor unit 215, the image processing unit 216, the display unit 217, and the audio outputting unit 218, and the controller 211 may manage data transmission/reception between the units.

In the present specification, the controller 211 detects the eye-gaze of the user and the turning of the user's head (or face), and, then, the controller 211 controls a respective unit in accordance with the detected result, thereby moving the virtual object of a layer, which is seen by user's eye-gaze. According to an exemplary embodiment of the present specification, the present specification describes an example of having the controller 211 perform detection of the user's eye-gaze and the turning of the user's head. However, this is merely an example given to facilitate the understanding of the present specification, and, therefore, the same procedure may be performed by a unit other than the controller 211. In the present specification, the detection of the eye-gaze or the turning of the head may be realized by using any one of hardware, firmware, middleware, and software, or may be realized by a combination of at least two of the same.

The communication unit 212 is connected to an external digital device 250 through wired or wireless connection. And, any device that can provide video/audio data to the wearable display device 200 may be used as the external digital device 250. For example, the external digital device 250 may either correspond to a mobile terminal (or user equipment) or may correspond to a fixed terminal (or user equipment). The mobile terminal may correspond to a mobile phone, a smart phone, a tablet Personal Computer (PC), a smart pad, a notebook, a digital broadcasting terminal (or user equipment), a Personal Digital Assistants (PDA), a Portable Multimedia Player (PMP), a digital camera, a navigation (or navigator), and so on, and the fixed terminal may correspond to a desktop, a Digital Video Disc (or Digital Versatile Disc) (DVD) player, a TV, and so on.

The communication unit 212 and the external digital device 250 may transmit/receive information via wired or wireless connection by using diverse protocols. For example, in case of a wired connection, an interface, such as High Definition Multimedia Interface (HDMI) or Digital Visual Interface (DVI), may be supported. In another example, in case of a wireless connection, 2G, 3G, and 4G mobile communication types, such as Global System for Mobile Communications (GSM) or Code Division Multiple Access (CDMA), Wibro, and other mobile communication types, such as High Speed Packet Access (HSPA), High Speed Downlink Packet Access (HSDPA), Long Term Evolution (LTE), and so on, or close-range communication type interfaces, such as Bluetooth, Radio Frequency Identification (RFID), infrared Data Association (IrDA), Ultra Wideband (UWB), Zigbee, Wireless LAN (WLAN) (or Wi-Fi), and so on, may be supported.

Herein, the wireless/wired interface types are exemplary embodiments provided to facilitate the understanding of the present specification, and, therefore, since the interface types for transmitting/receiving information may be easily varied or modified by anyone skilled in the art, in the present specification, the interface types will not be limited only to the exemplary embodiments presented and mentioned herein.

The camera unit 213 captures an image of the surrounding environment of the wearable display device and then converts the captured image to an electrical signal. In order to do so, the camera unit 213 may include an image sensor, and the image sensor may convert an optical signal to an electrical signal. The image that is captured by the camera unit 213 and then converted to the electrical signal may be stored in the storage unit 214 and then outputted to the controller 211, or the converted electrical signal may be directly outputted to the controller 211 without being stored. Additionally, the camera unit 213 captures an image of the user's face or an image of a range corresponding to the user's eye-gaze and converts the captured image to an electrical signal. Thereafter, the image that is converted to the electrical signal is stored in the storage unit 214 and then outputted to the controller 211, or the converted electrical signal is directly outputted to the controller 211 without being stored. The image being captured by the camera unit 213 may be a still image or may be a moving picture image.

The storage unit 214 may store an application (or program) for the operations of the controller 211, or the storage unit 214 may also store images acquired through the camera unit 213. Moreover, the storage unit 214 may also store diverse types of content, such as audio content, pictures, moving picture images, applications, and so on.

The storage unit 214 may correspond to a RAM (Random Access Memory), a Static Random Access Memory (SRAM), a Read Only Memory (ROM), an Electrically Erasable Programmable Read Only Memory (EEPROM), a Programmable Read Only Memory (PROM), and so on. Additionally, the wearable display device 200 may operate in association with a web storage performing the storage function of the storage unit 214 within the internet.

Additionally, the storage unit 214 may further include an external storage medium, which is detachably fixed to the wearable display device 200. The external storage medium may be made up of a slot type, such as a Secure Digital (SD) or Compact Flash (CF) memory, a memory stick type, a Universal Serial Bus (USB) type, and so on. More specifically, the external storage medium may be detachably fixed to the wearable display device 200, and any type of storage medium that can provide diverse types of content, such as audio content, pictures, moving picture images, applications, and so on, to the wearable display device 200 may be used as the external storage medium.

The sensor unit 215 may use a plurality of sensors equipped to the wearable display device 200, so as to be capable of delivering a user input or an environment, which is identified (or recognized) by the wearable display device 200, to the controller 211. At this point, the sensor unit may include a plurality of sensing means. According to an exemplary embodiment of the present specification, the plurality of sensing means may include a gravity sensor, a geomagnetic (or terrestrial magnetism) sensor, a motion sensor, a gyro sensor, an acceleration sensor, an infrared sensor, an inclination sensor, a brightness sensor, an altitude sensor, an odor sensor, a temperature sensor (or thermal sensor), a depth sensor, a pressure sensor, a banding sensor, an audio sensor, a video sensor, a touch sensor, and so on.

Among the plurality of sensing means, the pressure sensor may detect whether or not pressure is being applied to the wearable display device 200, a size of the pressure being applied to the wearable display device 200. The pressure sensor module may be installed on a portion of the wearable display device 200 that requires pressure detection in accordance with the usage environment.

The motion sensor may detect the rotation of the wearable display device 200 by using the acceleration sensor, the gyro sensor, and so on. More specifically, the controller 211 may calculate in which direction and by how many degrees the user wearing the wearable display device 200 has turned his (or her) head, by using the information sensed by the motion sensor, acceleration sensor, and gyro sensor of the sensing unit 215. The acceleration sensor, which may be used in the motion sensor, corresponds to a device that can convert a change in acceleration along any one direction to an electrical signal. And, such acceleration sensor is being widely used along with the development of an MEMS (micro-electromechanical systems) technology. Diverse types of acceleration sensors exist from an acceleration sensor being embedded in an airbag system of an automobile (or car), so as to be used for detecting collision, and measuring a high acceleration value to an acceleration sensor identifying fine movements of a user's hand, so as to be used as an input means for game playing, and so on, and measuring a minute acceleration value. Additionally, the gyro sensor corresponds to a sensor measuring angular velocity, which can detect a rotated direction with respect to a reference direction.

In the present specification, the sensor unit 215 collectively refers to the diverse sensing means that are described above. Herein, the sensor unit 215 may sense diverse input and the user's environment and may then deliver the sensed result to the controller 211, so that the controller 211 can perform operations respective to the sensed result. The above-described sensors may each be included in the wearable display device 200 as a separate element, or at least one or more sensors may be combined (or integrated), so as to be included in the wearable display device 200 as at least one or more elements.

The image processing unit 216 positions (or aligns) one or more virtual objects in one or more layers and, then, overlays (or overlaps) the one or more virtual objects over an image of the real world (or a reality image), which is captured by the camera unit 213. An augmented reality image, which is composed of an overlay of virtual objects of the one or more layers, is then displayed through the display unit 217.

More specifically, the camera unit 213 captures the image of the real world. Thereafter, the captured image is stored in the storage unit 214 and then outputted to the image processing unit 216, or the captured image is directly outputted to the image processing unit 216 without being stored. The image processing unit 216 overlays one or more virtual objects in a layer structure over the image of the real world, which is taken (or captured) by the camera unit 213, so as to create an augmented reality image. For example, when only the layers over the image of the real world, which is taken (or captured) by the camera unit 213, are defined, and after the user decides which layer is to be selected, the corresponding virtual object may be placed over the selected layer. Such layers operate as webpages of general browsers. Just as a large number of webpages can be used, a large number of layers may be similarly used.

Additionally, the display unit 217 outputs a video signal of a content that is being executed in the wearable display device 200. The content may be received from any one of the external digital device 250, the camera unit 213, and the storage unit 214. The display unit 217 may correspond to a liquid crystal display, a thin film transistor liquid crystal display, a light emitting diode, an organic light emitting diode, a flexible display, a three-dimensional display (3D display), and so on. Additionally, the display unit 217 may also correspond to an empty space (or the air) or a transparent glass that can display a virtual display screen. More specifically, any object that can visually deliver video signals to a human being may be used as the display unit 217.

The audio outputting unit 218 outputs an audio signal of a content that is being executed in the wearable display device 200. The content may be received from the storage unit 214, or may be received from the external digital device 250, or may be received from the camera unit 213.

The audio outputting unit 218 may include at least one of an air conduction speaker and a bone conduction speaker.

The bone conduction speaker may be positioned in diverse locations capable of easily providing the user with an audio signal, which is converted in the form of frequency resonance. When using the bone conduction speaker, by operating the bone conduction speaker, bone conduction sound wave is conducted to the user's cranial bone, and frequency type resonance is delivered to the user's internal ear (or inner ear). Thus, by using the bone conduction speaker, the user may be capable of hearing the audio signal without harming the user's eardrums.

The air conduction speaker corresponds to earphones, and so on. The air conduction speaker resonates (or oscillates) the air in accordance with the audio signal, so as to generate sound waves. More specifically, the resonance of the sound being delivered through the air is delivered to the eardrum, which is located inside of the ear, and the oscillation of the eardrum is delivered to a snail (or cochlea), which is composed of a helical form, after passing through 3 bones located inside the eardrum. The snail is filled with a fluid, which is referred to as lymph fluid, and oscillation occurring in this fluid is changed to electrical signals, which are delivered to auditory nerves, thereby allowing the user's brain to acknowledge the corresponding sound.

(a) to (d) of FIG. 3 respectively illustrate examples of movement in the user's eye-gaze and turning of the user's head when the user is wearing the wearable display device 200 according to the present specification. More specifically, (a) of FIG. 3 shows an example when the user's head is facing forward, and when the user's eye-gaze is also directed forward. In other words, the user's pupils are located at the center of the user's eyes. (b) of FIG. 3 shows an example when the user's head is facing forward, while the user's eye-gaze is shifted (or moved) to the right (or rightward). More specifically, the user's pupils are fixed to one side (i.e., right side end) of the user's eyes. (c) of FIG. 3 shows an example when the user's head is turned rightwards by a predetermined angle, and when the user's eye-gaze is gazing into the direction to which the user's head has turned (i.e., turning direction of the user's head). In other words, the user's pupils are located at the center of the user's eyes. (d) of FIG. 3 shows an example when the user's head is turned rightwards by a predetermined angle, while the user's eye-gaze is still directed forward. More specifically, the user's pupils are fixed to one side (i.e., right side end) of the user's eyes.

According to an exemplary embodiment of the present specification, the present specification describes examples of moving only a virtual object belonging to a layer being gazed upon by the user's eye-gaze, when the user's head is in a fixed state, while only the user's eye-gaze is moving, as shown in (b) of FIG. 3, and when the user's head is turning, while the user's eye-gaze is fixed, as shown in (d) of FIG. 3. At this point, in case the user's head is in a fixed state, while only the eye-gaze is moving, the moving direction and distance of the virtual object belonging to the layer, which is gazed upon by the user's eye-gaze, is calculated based upon a direction along which the user's eye-gaze is moving (i.e., a moving direction of the user's eye-gaze) and a moving distance of the user's eye-gaze. Meanwhile, in case the user's head is turning, while the user's eye-gaze is in a fixed state, the moving direction of the virtual object belonging to the layer being gazed upon by the user's eye-gaze corresponds to a direction opposite to that of the direction along which the user's head is turned (i.e., turning direction of the user's head), and the moving distance is calculated based upon the turned angle of the user's head (i.e., turning angle of the user's head).

In an embodiment of the present specification, when a virtual object belonging to one layer cannot be seen due to a portion of the corresponding virtual object being covered by a virtual object belonging to another layer, by moving the covered virtual object belonging to the layer under the same condition as that of (b) of FIG. 3 or (d) of FIG. 3, the virtual object belonging to the layer having at least a portion covered by the virtual object belonging to another layer may be seen.

(a) of FIG. 4 shows an example of the user viewing an augmented reality image as shown in (a) of FIG. 3. (a) of FIG. 4 shows an example of virtual objects 411 to 413 respectively belonging to first to third layers being displayed over an image of the real world (or a reality image) 400, which is taken (or captured) by the camera unit 213. In the present specification, the virtual object 411 belonging to the first layer will be referred to as the first virtual object 411 belonging to the first layer, the virtual object 412 belonging to the second layer will be referred to as the second virtual object 412 belonging to the second layer, and the virtual object 413 belonging to the third layer will be referred to as the third virtual object 413 belonging to the third layer for simplicity. Herein, a portion of the virtual object 412 belonging to the second layer and a portion of the virtual object 413 belonging to the third layer are covered (or hidden) by the virtual object belonging to the first layer 411, which is located as the uppermost layer (or top layer).

At this point, since the user's head is facing forward, and since the user's eye-gaze is also facing forward, even if the user's eye-gaze 420 is looking into the virtual object 413 belonging to the third layer, as shown in (a) of FIG. 4, the virtual object 413 of the third layer is not moved. More specifically, the layout (or positioning) of the virtual objects 411 to 413 respectively belonging to the first to third layers remains unchanged. Therefore, the user is unable to see the portion of the virtual object 413 belonging to the third layer, which is hidden (or covered) by the virtual object 411 belonging to the first layer.

(b) of FIG. 4 shows an example of the user viewing an augmented reality image as shown in (b) of FIG. 3. At this point, since the user's head is facing forward, and since only the user's eye-gaze is moved rightward as shown in (a) of FIG. 4 to (b) of FIG. 4, the virtual object 413 belonging to the third layer, which is seen through the user's eye-gaze, is also moved rightward. In this case, the moving direction and moving distance of the virtual object 413 belonging to the third layer is calculated based upon the moving direction and moving direction of the user's eye-gaze. Thus, the user may be capable of viewing (or seeing) the portion of the virtual object 413 belonging to the third layer, which is covered (or hidden) by the virtual object 411 belonging to the first layer. Meanwhile, when the user's head is facing forward, as shown in (a) of FIG. 4, and when only the user's eye-gaze is moved leftward, the virtual object 413 belonging to the third layer, which is gazed upon by the user's eye-gaze, is also moved leftward. Accordingly, the virtual object 413 belonging to the third layer is even more covered by the virtual object 411 belonging to the first layer 411, thereby preventing an even larger portion of the virtual object 413 belonging to the third layer to be unseen by the user.

(a) of FIG. 5 shows an example of the user viewing an augmented reality image as shown in (a) of FIG. 3. More specifically, the drawing shown in (a) of FIG. 5 is identical to the drawing shown in (a) of FIG. 4.

(b) of FIG. 5 shows an example of the user viewing an augmented reality image as shown in (c) of FIG. 3. More specifically, (b) of FIG. 5 shows an example of a case when the user is looking into (or seeing or gazing upon) the virtual object 412 belonging to the second layer, while the user's eye-gaze and head are both facing forward, as shown in (a) of FIG. 5, and then, when the user turns his (or her) head rightward, as shown in (b) of FIG. 5, and when the eye-gaze of the user also turns rightward.

At this point, since the eye-gaze of the user turns rightward along with the turning of the head, which is turned rightward, the layout (or positioning) of the virtual objects 411 to 413 respectively belonging to the first to third layers remains unchanged. Therefore, even if the user's eye-gaze is looking into (or gazing upon) the virtual object 412 belonging to the second layer, the user is unable to see the portion of the virtual object 412 belonging to the second layer, which is hidden (or covered) by the virtual object 411 belonging to the first layer.

(a) of FIG. 6 shows an example of the user viewing an augmented reality image as shown in (a) of FIG. 3. More specifically, the drawing shown in (a) of FIG. 6 is identical to the drawing shown in (a) of FIG. 5. In (a) of FIG. 5, the user's eye-gaze 420 is facing into the virtual object 413 belonging to the third layer. However, in (a) of FIG. 6, the user's eye-gaze 420 is facing into the virtual object 412 belonging to the second layer.

(b) of FIG. 6 shows an example of the user viewing an augmented reality image as shown in (d) of FIG. 3. More specifically, (b) of FIG. 6 shows an example of the eye-gaze of the user, which is looking into the virtual object 412 belonging to the second layer, moving leftward.

In other words, when the user gazes upon the virtual object 412 of the second layer, while the user's eye-gaze and head are both facing forward, as shown in (a) of FIG. 6, and, then, when the user turns his (or her) head rightward while fixing his (or her) eye-gaze, the virtual object 412 belonging to the second layer, which is seen through the user's eye-gaze, is moved leftward, as shown in (b) of FIG. 6. At this point, the moving direction of the virtual object 412 belonging to the second layer corresponds to a direction opposite to the turning of the head, and the moving distance of the virtual object 412 belonging to the second layer is calculated based upon the turning degree (i.e., distance) of the user's head.

According to another exemplary embodiment of the present specification, when the user's head is turned rightward, and when the user's eye-gaze is also moved rightward, so as to look into the virtual image 412 belonging to the second layer, and, then, when only the user's eye-gaze is moved leftward, the virtual object 412 belonging to the second layer, which is seen through the user's eye-gaze, is moved leftward, as shown in (b) of FIG. 6. In this case, the moving direction and moving distance of the virtual object 412 belonging to the second layer is calculated based upon the moving direction and moving direction of the user's eye-gaze. Meanwhile, when the user's head is turned leftward, and when the user's eye-gaze is also turned leftward, so as to gaze upon (or look into) the virtual object 412 belonging to the second layer, and, then, when only the eye-gaze of the user is moved (or turned) rightward, the virtual object 412 belonging to the second layer, which is seen through the user's eye-gaze, is also moved rightward. Accordingly, the virtual object 412 belonging to the second layer is even more covered by the virtual object 411 belonging to the first layer 411, thereby preventing an even larger portion of the virtual object 412 belonging to the second layer to be unseen by the user.

An exemplary embodiment of the controller 211 tracking a virtual object belonging to a layer, which is gazed upon by the user's eye-gaze, will hereinafter be described in detail.

In order to do so, the camera unit 213 captures an image (or takes a picture) of the user's face and outputs the captured image to the controller 211. The controller 211 extracts an image of the user's eye (i.e., eye image) from the image of the face (i.e., face image), which is captured by the camera unit 213, and then calculates a center point of the pupil from the extracted eye image.

Herein, the pupil corresponds to a circular part of the eye, which is located at the center of the user's eye and encircle by the iris. The pupil is the darkest part of the eye and is generally black, especially in the eyes of people from Asian origin. The eye-gaze of the user may be closely related to the user's pupils. For example, a specific point, which is looked into by the user with interest, may be substantially identical to a direction which the center point of the user's pupil is facing into.

Thereafter, the controller 211 calculates the direction of the eye-gaze based upon the movement of the user's head, i.e., based upon how much and along which direction the user turns his (or her) head. More specifically, the movement of the user's head may correspond to an element (or factor) for calculating the direction of the user's eye-gaze along with the center point of the user's pupil. For example, this may indicate that, even when the user is facing forward without moving his (or her) pupils, when the user turns his (or her) left-to-right and vice versa, the direction of the user's eye-gaze may vary. In this case, the movement of the user's head may be detected by using at least one of the sensors included in the sensor unit 215, or may be detected by using the face image of the user taken (or captured) by the camera unit 213.

More specifically, the controller 211 may calculate the direction of the user's eye-gaze based upon the movement of the user's head and the center point of the user's pupils. Additionally, the controller 211 may also determine which layer of the virtual object is being viewed (or looked into or gazed upon) by the user in the augmented reality image.

FIG. 7 illustrates a flow chart showing process steps of a method for controlling an augmented reality layer in the wearable display device according to an exemplary embodiment of the present specification.

Referring to FIG. 7, it is determined whether or not at least any one of a movement in the user's eye-gaze and a turning of the user's head is being detected (S601). More specifically, the user may move only his (or her) eye-gaze while maintaining his (or her) head in a fixed state, or the user may move only his (or her) head while maintaining his (or her) eye-gaze in a fixed state, or the user may turn his (or her) head while moving his (or her) eye-gaze at the same time. According to the exemplary embodiment of the present specification, when the user turns his (or her) head while moving his (or her) eye-gaze, the turning direction of the user's head and the moving direction of the user's eye-gaze may be the same. In other words, if the user turns his (or her) head rightward, the user may move his (or her) eye-gaze rightward, and, similarly, if the user turns his (or her) head leftward, the user may move his (or her) eye-gaze leftward.

In step S601, when it is determined that the user's eye-gaze is moved, the procedure for controlling the augmented reality layer proceeds to step S602, so as to verify the moving direction of the user's eye-gaze (S602). If the user's eye-gaze is moved rightward, the procedure proceeds to step S603, so as to determine whether or not the user's head is also turned, and, if the user's eye-gaze is moved leftward, the procedure proceeds to step S604, so as to determine whether or not the user's head is also turned.

In step S603, if it is determined that the user has not turned his (or her) head, this indicates that the user has moved his (or her) eye-gaze rightward, while maintaining his (or her) head in a fixed state. In this case, the procedure proceeds to step S710, so as to move the virtual object belonging to the layer, which is gazed upon (or seen) by the user's eye-gaze, rightward. At this point, the moving direction and distance of the virtual object belonging to the layer, which is gazed upon by the user's eye-gaze, is calculated based upon the moving direction and distance of the user's eye-gaze.

In step S603, if it is determined that the user has also turned his (or her) head, this indicates that the user has moved his (or her) eye-gaze rightward, while also turning his (or her) head rightward. In this case, the procedure proceeds to step S720, so as to move the virtual objects respectively belonging to all layers within the augmented reality image rightward. More specifically, the layout (or positioning) of the virtual objects respectively belonging to all layers within the augmented reality image remains unchanged.

In step S604, if it is determined that the user has not turned his (or her) head, this indicates that the user has moved his (or her) eye-gaze leftward, while maintaining his (or her) head in a fixed state. In this case, the procedure proceeds to step S730, so as to move the virtual object belonging to the layer, which is gazed upon (or seen) by the user's eye-gaze, leftward. At this point, the moving direction and distance of the virtual object belonging to the layer, which is gazed upon (or seen) by the user's eye-gaze, is calculated based upon the moving direction and distance of the user's eye-gaze.

In step S604, if it is determined that the user has also turned his (or her) head, this indicates that the user has moved his (or her) eye-gaze leftward, while also turning his (or her) head leftward. In this case, the procedure proceeds to step S740, so as to move the virtual objects respectively belonging to all layers within the augmented reality image leftward. More specifically, the layout (or positioning) of the virtual objects respectively belonging to all layers within the augmented reality image remains unchanged.

In step S601, when it is determined that the user's head is turned, the procedure for controlling the augmented reality layer proceeds to step S605, so as to verify the turning direction of the user's head. If the user's head is turned rightward, the procedure proceeds to step S606, so as to determine whether or not the user's eye-gaze is also moved, and, if the user's head is turned leftward, the procedure proceeds to step S607, so as to determine whether or not the user's eye-gaze is also moved.

In step S606, if it is determined that the user has not moved his (or her) eye-gaze, this indicates that the user has only turned his (or her) head rightward, while maintaining his (or her) eye-gaze in a fixed state. In this case, the procedure proceeds to step S730, so as to move the virtual object belonging to the layer, which is seen by the user's eye-gaze, leftward, which corresponds to a direction opposite to the direction along which the user's head is turned. At this point, the moving direction of the virtual object belonging to the layer, which is seen by the user's eye-gaze, and the direction along which the user turns his (or her) head are opposite to one another, and the moving distance is calculated based upon the turning distance of the user's head.

In step S606, if it is determined that the user has also moved his (or her) eye-gaze, this indicates that the user has moved his (or her) eye-gaze rightward, while also turning his (or her) head rightward. In this case, the procedure proceeds to step S720, so as to move the virtual objects respectively belonging to all layers within the augmented reality image rightward. More specifically, the layout (or positioning) of the virtual objects respectively belonging to all layers within the augmented reality image remains unchanged.

In step S607, if it is determined that the user has not moved his (or her) eye-gaze, this indicates that the user has only turned his (or her) head leftward, while maintaining his (or her) eye-gaze in a fixed state. In this case, the procedure proceeds to step S710, so as to move the virtual object belonging to the layer, which is seen by the user's eye-gaze, rightward. At this point, the moving direction of the virtual object belonging to the layer, which is seen by the user's eye-gaze, and the direction along which the user turns his (or her) head are opposite to one another, and the moving distance is calculated based upon the turning distance of the user's head.

In step S607, if it is determined that the user has also moved his (or her) eye-gaze, this indicates that the user has moved his (or her) eye-gaze leftward, while also turning his (or her) head leftward. In this case, the procedure proceeds to step S740, so as to move the virtual objects respectively belonging to all layers within the augmented reality image leftward. More specifically, the layout (or positioning) of the virtual objects respectively belonging to all layers within the augmented reality image remains unchanged.

Provided above is a detailed description of exemplary embodiments of moving an virtual object belonging to a layer, which is gazed upon by the user's eye-gaze, within an augmented reality image, which is made up of virtual objects respectively belonging to a plurality of layers overlaying over an image of the real world (or a reality image) captured (or taken) by a camera unit 213.

Additionally, by applying the above-described exemplary embodiments of the present specification to an image displaying only virtual layers respectively belonging to a plurality of layers without any reality image, the virtual object belonging to a layer, which is gazed upon (or seen) by the user, may be moved.

The wearable display device and the method for controlling a layer in the same have the following advantages. By detecting the eye-gaze of the user and the rotation of the wearable display device (i.e., turning of the user's head) from the wearable display device, which is worn on the user's head, and by moving the virtual object of a layer, which is viewed (or gazed upon) by the user's eye-gaze, in accordance with the detected result, the present specification allows the virtual object of a layer, which could not be seen because of a portion of a virtual object of another layer covering (or hiding) the corresponding virtual object, to be seen (by the user).

It will be apparent to those skilled in the art that various modifications and variations can be made in the present specification without departing from the spirit or scope of the specifications. Thus, it is intended that the present specification covers the modifications and variations of this specification provided they come within the scope of the appended claims and their equivalents.

What is claimed is:

1. A wearable display device, comprising:
a display unit configured to display a first virtual object belonging to a first layer and a second virtual object belonging to a second layer;
a camera unit configured to capture an image of a user's face;
a sensor unit configured to sense whether the user is turning his (or her) head; and
a controller configured to move a virtual object belonging to a layer being gazed upon by the user's eye-gaze when at least one of a turning of the user's head and a movement in the user's eye-gaze is identified based on the image of the user's face captured by the camera unit and information sensed by the sensor unit, and when the user's eye-gaze is gazing upon any one of the first virtual object belonging to the first layer and the second virtual object belonging to the second layer.

2. The wearable display device of claim 1, wherein the controller detects pupils of the user's eyes from the captured image of the user's face, and wherein the controller detects a gazing direction of the user's eye-gaze based on the detected pupil information and whether the user has turned his (or her) head.

3. The wearable display device of claim 1, wherein the controller moves the virtual object belonging to the layer being gazed upon by the user's eye-gaze, when the user's eye-gaze is in a fixed state, while the user's eye-gaze is gazing upon any one of the first virtual object belonging to the first layer and the second virtual object belonging to the second layer, and when the user's head is turned sideways.

4. The wearable display device of claim 3, wherein a moving direction of the virtual object belonging to the layer that is being moved corresponds to an opposite direction of a turning direction of the user's head.

5. The wearable display device of claim 3, wherein a moving distance of the virtual object belonging to the layer that is being moved is calculated based on a turning distance of the user's head.

6. The wearable display device of claim 1, wherein the controller moves the virtual object belonging to the layer being gazed upon by the user's eye-gaze, when the user's head is in a fixed state, while the user's eye-gaze gazes upon any one of the first virtual object belonging to the first layer and the second virtual object belonging to the second layer, and when the user's eye-gaze is moved afterwards.

7. The device of claim 6, wherein a moving direction of the virtual object belonging to the layer that is being moved corresponds to the same direction as a moving direction of the user's eye-gaze.

8. The wearable display device of claim 6, wherein a moving distance of the virtual object belonging to the layer that is being moved is calculated based on a moving distance of the user's eye-gaze.

9. The wearable display device of claim 1, wherein the controller senses a turning direction and a turning distance of the user's head by using at least one of a motion sensor, an acceleration sensor, and a gyro sensor.

10. The wearable display device of claim 1, wherein the controller senses a turning direction and a turning distance of the user's head based on the captured image of the user's face.

11. The wearable display device of claim 1, wherein the camera unit captures a reality image, and
wherein the display unit displays an augmented reality image by overlaying the first virtual object belonging to the first layer and the second virtual object belonging to the second layer over the captured reality image.

12. A method for controlling a layer in a wearable display device, the method comprising:
displaying a first virtual object belonging to a first layer and a second virtual object belonging to a second layer;
capturing an image of a user's face;
sensing whether the user is turning his (or her) head; and
moving a virtual object belonging to a layer being gazed upon by the user's eye-gaze, when at least one of a turning of the user's head and a movement in the user's eye-gaze is identified based on the captured image of the user's face and the sensed information, and when the user's eye-gaze is gazing upon any one of the first virtual object belonging to the first layer and the second virtual object belonging to the second layer.

13. The method of claim 12, wherein pupils of the user's eyes are detected from the captured image of the user's face, and wherein a gazing direction of the user's eye-gaze is detected based on the detected pupil information and whether or not the user has turned his (or her) head.

14. The method of claim 12, wherein the virtual object belonging to the layer being gazed upon by the user's eye-gaze is moved, when the user's eye-gaze is in a fixed state, while the user's eye-gaze is gazing upon any one of the first virtual object belonging to the first layer and the second virtual object belonging to the second layer, and when the user's head is turned sideways.

15. The method of claim 14, wherein a moving direction of the virtual object belonging to the layer that is being moved corresponds to an opposite direction of a turning direction of the user's head.

16. The method of claim 14, wherein a moving distance of the virtual object belonging to the layer that is being moved is calculated based on a turning distance of the user's head.

17. The method of claim 12, wherein the virtual object belonging to the layer being gazed upon by the user's eye-gaze is moved, when the user's head is in a fixed state, while the user's eye-gaze gazes upon any one of the first virtual object belonging to the first layer and the second virtual object belonging to the second layer, and when the user's eye-gaze is moved afterwards.

18. The method of claim 17, wherein a moving direction of the virtual object belonging to the layer that is being moved corresponds to the same direction as a moving direction of the user's eye-gaze.

19. The method of claim 17, wherein a moving distance of the virtual object belonging to the layer that is being moved is calculated based on a moving distance of the user's eye-gaze.

20. The method of claim 12, further comprising:
capturing a reality image, and
displaying an augmented reality image by overlaying the first virtual object belonging to the first layer and the second virtual object belonging to the second layer over the captured reality image.
